(19) United States
(12) Patent Application Publication
(10) Pub. No.: US 2026/0106491 A1
(43) Pub. Date: Apr. 16, 2026

(54) ELECTRONIC DEVICE, METHOD, AND NON-TRANSITORY STORAGE MEDIUM FOR WIRELESS CHARGING

(71) Applicant: Samsung Electronics Co., Ltd., Suwon-si (KR)

(72) Inventors: Youngjoon PARK, Suwon-si (KR); Dongzo KIM, Suwon-si (KR); Woojin JUNG, Suwon-si (KR)

(21) Appl. No.: 19/240,657

(22) Filed: Jun. 17, 2025

(30) Foreign Application Priority Data
Oct. 11, 2024 (KR) 10-2024-0138897

(51) Int. Cl. H02J 50/12; H02J 7/00; H02J 50/00; H02J 50/60; H02J 50/90

(52) U.S. Cl. CPC H02J 50/12; H02J 7/82; H02J 50/005; H02J 50/60; H02J 50/90

(57) ABSTRACT

A method operating an electronic device is provided. The method includes, based on identifying that the electronic device is disposed within a designated distance from a wireless power transmission device using a first ping signal received from the wireless power transmission device and having a first cycle and a first current value, receiving power for wirelessly charging a battery through a coil of the electronic device from the wireless power transmission device, identifying entry into a power hold mode (PHM) while receiving the power, and based on receiving a second ping signal having a second cycle and a second current value from the wireless power transmission device while in the power hold mode, identifying that the first ping cycle is changed to the second ping cycle by the wireless power transmission device and maintaining a state of charging the battery by wirelessly receiving the power from the wireless power transmission device without stopping the charging of the battery.

### CROSS-REFERENCE TO RELATED APPLICATION(S)

This application is based on and claims priority under 35 U.S. C. § 119(a) of a Korean patent application number 10-2024-0138897, filed on Oct. 11, 2024, in the Korean Intellectual Property Office, the disclosure of which is incorporated by reference herein in its entirety.

### BACKGROUND

### 1. Field

The disclosure relates to an electronic device, a method, and a non-transitory storage medium for wireless charging.

### 2. Description of Related Art

With digital technology advancing, electronic devices come in various types, such as smartphones, tablet personal computers (PCs), or personal digital assistants (PDAs). Electronic devices have been developed to be worn by users so as to enhance portability and user accessibility.

Electronic devices are providing more diversified services and additional functions. Steady development efforts are underway for electronic devices to meet various needs of users and to raise the usability of electronic devices.

As technology advances, wireless charging technology using wireless power transmission/reception is being developed, and wireless charging technology may automatically charge a battery, e.g., by simply placing an electronic device on a charging device without connecting it to a separate charging connector.

The above information is presented as background information only to assist with an understanding of the disclosure. No determination has been made, and no assertion is made, as to whether any of the above might be applicable as prior art with regard to the disclosure.

### SUMMARY

In electronic devices utilizing wireless charging technology, as the area of the hinge member including a metal material increases or as the hinge member is positioned closer to the coil, a foreign object detection (FOD) operation may be more often performed and, due to induction heating by the hinge member, more heat generation may occur. However, due to the limited product design, the coil may inevitably be positioned close to the hinge member. Although the electronic device enters a power hold mode (PHM), heat may be generated by induction heating due to a ping signal with a short cycle (e.g., 170 ms).

Aspects of the disclosure are to address at least the above-mentioned problems and/or disadvantages and to provide at least the advantages described below. Accordingly, an aspect of the disclosure is to provide an electronic device, a method, and a non-transitory storage medium for wireless charging.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a second housing rotatably connected to a portion of the first housing to be opened or closed, a hinge member rotatably connecting the first housing and the second housing and including a metal material, a coil disposed adjacent to the hinge member in the first housing, a battery disposed in the first housing, memory, comprising one or more storage media, storing instructions, and at least one processor communicatively coupled to the battery and the memory, wherein the instructions, when executed by the at least one processor individually or collectively, cause the electronic device to, based on identifying that the electronic device is disposed within a designated distance from a wireless power transmission device using a first ping signal received from the wireless power transmission device and having a first cycle and a first current value, receive power for wirelessly charging the battery through the coil from the wireless power transmission device, identify entry into a power hold mode (PHM) while receiving the power based on receiving a second ping signal having a second cycle and a second current value from the wireless power transmission device while in the power hold mode, identify that the first ping cycle is changed to the second ping cycle by the wireless power transmission device and maintain a state of charging the battery by wirelessly receiving the power from the wireless power transmission device without stopping the charging of the battery, wherein the second current value of the second ping signal is greater or equal to a reference value, and wherein the second ping cycle is longer than the first ping cycle to reduce heat generation by the hinge member while charging the battery of the electronic device.

In accordance with another aspect of the disclosure, a method for an operation in an electronic device is provided. The method includes, based on identifying that the electronic device is disposed within a designated distance from a wireless power transmission device using a first ping signal received from the wireless power transmission device and having a first cycle and a first current value, receiving power for wirelessly charging a battery of the electronic device through a coil of the electronic device from the wireless power transmission device, wherein the coil is configured to be disposed in a first housing, adjacent to a hinge member including a metal material rotatably connecting the first housing of the electronic device and a second housing of the electronic device, identifying entry into a power hold mode (PHM) while receiving the power, based on receiving a second ping signal having a second cycle and a second current value from the wireless power transmission device while in the power hold mode, identifying that the first ping cycle is changed to the second ping cycle by the wireless power transmission device and maintaining a state of charging the battery by wirelessly receiving the power from the wireless power transmission device without stopping the charging of the battery, wherein the second current value of the second ping signal is greater or equal to a reference value, and wherein the second ping cycle is longer than the first ping cycle to reduce heat generation by the hinge member while charging the battery of the electronic device.

In accordance with another aspect of the disclosure, one or more non-transitory computer-readable storage media storing one or more computer programs including computer-executable instructions that, when executed by at least one processor of an electronic device, cause the electronic device to perform operations are provided. The operations include, based on identifying that the electronic device is disposed within a designated distance from a wireless power transmission device using a first ping signal received from the wireless power transmission device and having a first cycle and a first current value, receiving power for wirelessly charging a battery of the electronic device through a coil of the electronic device from the wireless power transmission device, wherein the coil is configured to be disposed in a first housing, adjacent to a hinge member including a metal material rotatably connecting the first housing of the electronic device and a second housing of the electronic device, identifying entry into a power hold mode (PHM) while receiving the power, and based on receiving a second ping signal having a second cycle and a second current value from the wireless power transmission device while in the power hold mode, identifying that the first ping cycle is changed to the second ping cycle by the wireless power transmission device and maintaining a state of charging the battery by wirelessly receiving the power from the wireless power transmission device without stopping the charging of the battery, wherein the second current value of the second ping signal is a reference value or more, and wherein the second ping cycle is longer than the first ping cycle to reduce heat generation by the hinge member while charging the battery of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a view illustrating a wireless power transmission device and a wireless power reception device according to an embodiment of the disclosure;

FIG. 3 is a view illustrating a structure of a wireless power transmission device according to an embodiment of the disclosure;

FIGS. 4A, 4B, and 4C are views illustrating a structure of an electronic device which is a wireless power reception device according to various embodiments of the disclosure;

FIG. 5 is a view illustrating a wireless power transmission device and a wireless power reception device according to an embodiment of the disclosure;

FIG. 6 is a view illustrating an example of a ping phase for wireless charging according to an embodiment of the disclosure;

FIG. 7 is a view illustrating an example of an operation method in an electronic device according to an embodiment of the disclosure; and

FIG. 8 is a view illustrating an effect according to wireless charging in an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

As used herein, the term “user” may denote a human or another device (e.g., an artificial intelligent electronic device) using the electronic device.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

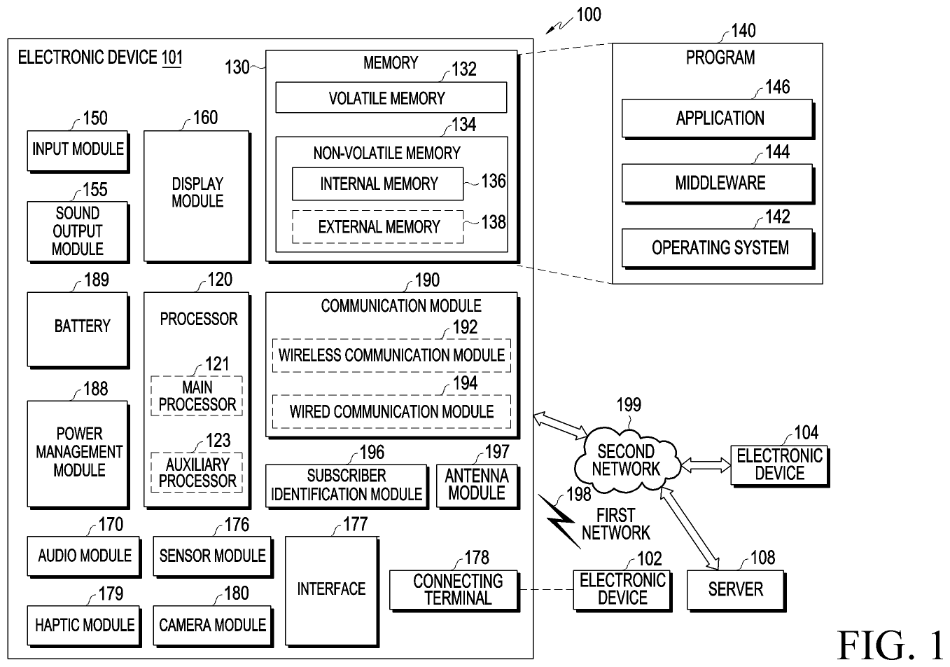

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

In the disclosure, the term “module” of the components may be replaced with the term “circuit”.

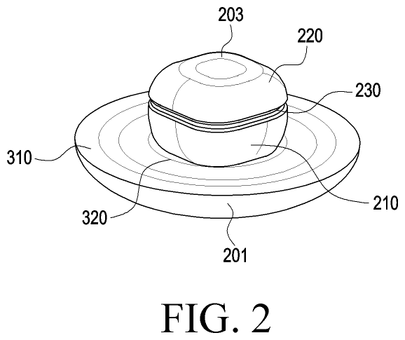

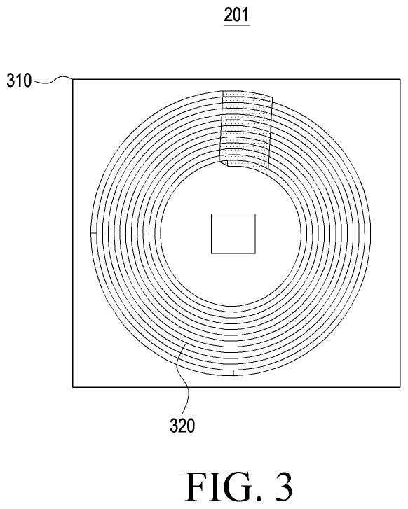

FIG. 2 is a view illustrating a wireless power transmission device and a wireless power reception device according to an embodiment of the disclosure. FIG. 3 is a view illustrating a structure of a wireless power transmission device according to an embodiment of the disclosure.

Referring to FIGS. 2 and 3, a wireless power transmission device 201 (e.g., the electronic device 102 of FIG. 1) according to an embodiment may wirelessly transmit power to a wireless power reception device 203 (e.g., the electronic device 101 of FIG. 1). The wireless power transmission device 201 may receive information from the electronic device 101. For example, the wireless power transmission device 201 may transmit power in an induction scheme. Adopting the induction scheme, the wireless power transmission device 201 may include at least one of, e.g., a power source, a DC-DC conversion circuit (e.g., DC/DC converter), DC-AC conversion circuit (e.g., inverter), an amplifying circuit, an impedance matching circuit, at least one capacitor, at least one coil 320, or a communication modulation circuit. The at least one capacitor together with the at least one coil 320 may constitute a resonance circuit. The wireless power transmission device 201 may implement at least part of the schemes defined in the wireless power consortium (WPC) Qi standard. The wireless power transmission device 201 may include a coil that is capable of produce a magnetic field when letting an electric current flow thereacross by an induction scheme. The process of the wireless power transmission device 201 producing an induced magnetic field may be represented as the wireless power transmission device 201 wirelessly transmitting power. Further, an induced electromotive force (or current, voltage, and/or power) may be generated by the magnetic field generated around the coil of the wireless power reception device 203 according to a resonance scheme or an induction scheme. The process of producing an induced electromotive force through the coil may be represented as the electronic device 203 wirelessly receiving power.

The wireless power transmission device 201 according to an embodiment may communicate with the electronic device 203. For example, the wireless power transmitting device 201 may communicate with the wireless power reception device 203 according to an in-band scheme. The wireless power transmitting device 201 may modulate data to be transmitted according to, e.g., a frequency shift keying (FSK) modulation scheme, and the electronic device 203 may perform modulation according to an amplitude shift keying (ASK) modulation scheme, thereby providing information. The wireless power transmitting device 201 may identify the information provided by the wireless power reception device 203 based on the amplitude of the current and/or voltage applied to the transmission coil.

In the disclosure, that the wireless power transmitting device 201 or the wireless power reception device 203 performs a specific operation may mean that various pieces of hardware included in the wireless power transmitting device 201 or the wireless power reception device 203, e.g., a controller (e.g., a micro-controlling unit (MCU), a field programmable gate array (FPGA), an application specific integrated circuit (ASIC), a microprocessor, or an application processor (AP)) performs the specific operation. Or, that the wireless power transmitting device 201 or the wireless power reception device 203 performs a specific operation may also mean that the connector controls another hardware device to perform the specific operation. That the wireless power transmitting device 201 or the wireless power reception device 203 performs a specific operation may mean that the controller (e.g., a processor) or another hardware device triggers the specific operation as an instruction for performing the specific operation, which is stored in a storage circuit (e.g., memory) of the wireless power transmitting device 201 or the wireless power reception device 203, is executed.

In the disclosure, the wireless power transmission device 201 may perform a ping, identification and configuration, negotiation for FOD determination, and power transfer phase to transmit power to the wireless power reception device 203 according to the scheme defined in the Qi standard of the wireless power consortium (WPC).

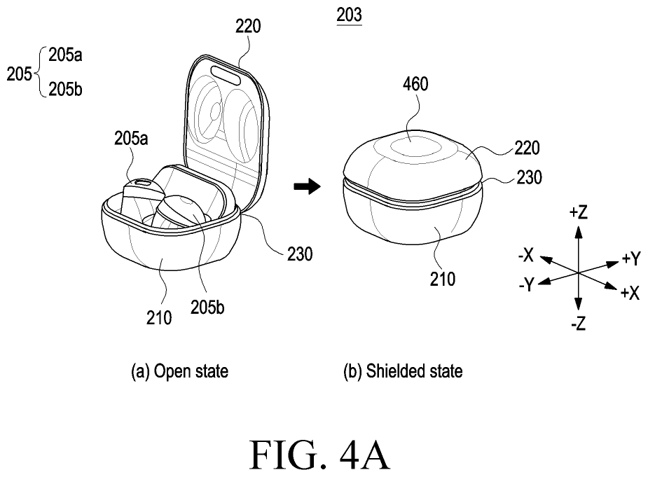

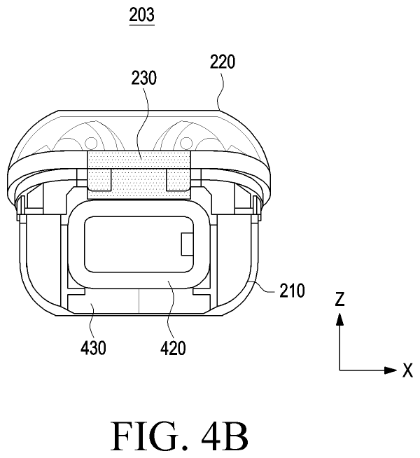

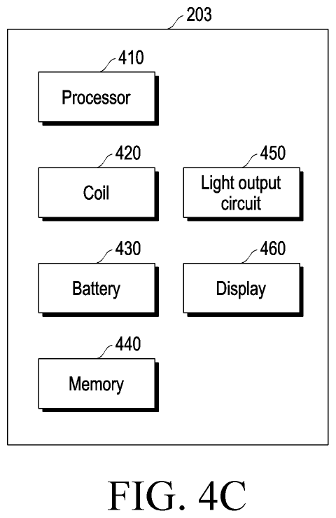

FIGS. 4A, 4B, and 4C are views illustrating a structure of an electronic device which is a wireless power reception device according to various embodiments of the disclosure.

Referring to FIGS. 4A, 4B, and 4C, an electronic device 203 according to an embodiment may include a first housing 210, a second housing 220, and a connection member (e.g., a hinge member). The electronic device 203 according to an embodiment may include a processor 410, a battery 430, a coil 420, memory 440, and a light output circuit 450. The electronic device 203 according to an embodiment may further include a display 460 and/or a communication circuit (not shown). Without limitations thereto, the electronic device 203 may not include the display 460 and/or the communication circuit (not shown), or may further include other components described in FIG. 1.

The electronic device 203 according to an embodiment may be, e.g., a cradle device configured in the form of a case capable of storing the external electronic devices 205a and 205b, and a foldable or flip-type electronic device in which a portion of the housing is folded. In the disclosure, it will be understood that the electronic device 203 may be equally applied to all types of devices for charging, including a connection member 230 (e.g., a hinge member) formed of metal (e.g., a metal component) disposed in the folded portion of the housing.

The electronic device 203 according to an embodiment may be connected to a wireless transmission power device 201 that supplies external power to receive power supplied from the wireless transmission power device 201 to charge the battery. The electronic device 203 according to an embodiment may be wirelessly or wiredly connected to the external electronic devices 205a and 205b based on the mounting of the external electronic devices 205a and 205b in the inner accommodation space of the first housing 210, and may apply power for charging to the external electronic devices 205a and 205b.

According to an embodiment, the second housing 220 may be configured to be disposed on the first housing 210 to be connected to a portion of the first housing 210 through the connection member 230 to be opened or closed. According to an embodiment, as shown in FIGS. 4A and 4B, the connection member 230 may rotatably connect the first housing 210 and the second housing 220 with respect to the X axis (e.g., +axis and −axis), and may be formed of metal (e.g., a metal component). Here, as shown in FIG. 4A, the connection member 230 may be disposed in the +y-axis direction (e.g., the rear surface as shown in FIG. 4B).

According to an embodiment, various electronic components may be disposed inside the first housing 210 and/or the second housing 220. According to an embodiment, the first external electronic device 203 may include a display 460 in an area exposed to the outside of the second housing 220, and may display charging status information (e.g., information indicating start battery charging, charging, or stop charging) through the display 460.

According to an embodiment, the electronic device 203 may have an open state a and a shielded state b. The open state may refer to a state in which the second housing 220 does not shield the first housing 210 and the upper portion (e.g., +z-axis direction) of the first housing 210 is open. The shielded state may refer to a state in which the second housing 220 shields the first housing 210. In the following description, the disclosure is described using the terms ‘open state’ and ‘shielded state’.

According to an embodiment, the coil 420 of the electronic device 203 may be disposed adjacent to a connection member 230 in a portion of the first housing 210.

According to an embodiment, if the size of the coil 420 of the electronic device 203 is small as compared with the size (e.g., 44 mm) of the coil 320 of the wireless power transmission device 201, charging may not properly be performed or efficiency may be lowered, generating lots of heat during charging. Thus, the size of the coil 420 of the electronic device 203 may be implemented to be a size similar to the size (e.g., 44 mm) of the coil 320 of the wireless power transmission device 201 to increase the coupling coefficient to increase charging efficiency.

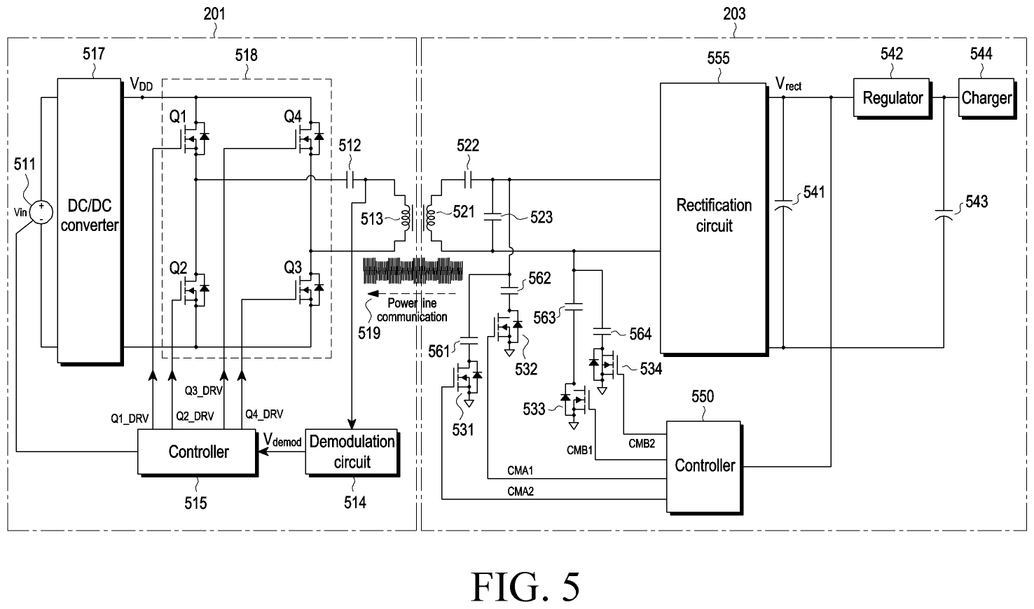

FIG. 5 is a view illustrating a wireless power transmission device and a wireless power reception device according to an embodiment of the disclosure.

According to an embodiment, the wireless power transmitting device 201 may include a power source 511, an inverter 518 including a plurality of switches Q1, Q2, Q3, and Q4, a capacitor 512, a transmission coil 513 (e.g., the coil 320 of FIGS. 2 and 3), a demodulation circuit 514, a controller 515 (e.g., a processor), and a DC/DC converter 517. According to an embodiment, the power provided by the power source 511 may be provided to the DC/DC converter 517. The power source 511 may include at least one of an interface for connection with an external travel adapter (TA), a battery (not shown) of the wireless power transmitting device 201, a charger (not shown), or a power management integrated circuit (PMIC) (not shown). The power source 511 may provide, e.g., DC power to the DC/DC converter 517, but the type of power provided is not limited. The DC/DC converter 517 may convert the voltage of the received power and apply it to the inverter 518. The DC/DC converter 517 may change the voltage of the applied DC power and provide the DC power having the changed voltage (or driving voltage VDD) to the inverter 518. The DC/DC converter 517 may perform, e.g., buck conversion and/or boost conversion and may be implemented as, e.g., a 3-level converter, but it will be appreciated by one of ordinary skill in the art that it is not limited in type.

According to an embodiment, the inverter 518 may output AC power using the driving voltage VDD received from the DC/DC converter 517. The plurality of switches Q1, Q2, Q3, and Q4 may constitute, e.g., a full bridge circuit, but the number of switches or the type of bridge circuit is not limited. For example, when a full bridge circuit is configured, one end of the transmission coil 513 may be connected to a connection point between the switches Q1 and Q2 through the capacitor 512, and the other end of the transmission coil 513 may be connected to the connection point between the switches Q3 and Q4. The plurality of switches Q1, Q2, Q3, and Q4 may be controlled to have an on state or an off state. For example, to generate AC power, the controller 515 may control the second switch Q2 and the fourth switch Q4 in the off state while controlling the first switch Q1 and the third switch Q3 in the on state during a first period and may control the second switch Q2 and the fourth switch Q4 in the on state while controlling the first switch Q1 and the third switch Q3 in the off state during a second period and may repeatedly perform the above-described control operations. The controller 515 may provide the control signals Q1_DRV, Q2_DRV, Q3_DRV, and Q4_DRV for generating AC power described above to the plurality of switches Q1, Q2, Q3, and Q4. Here, not only outputting the control signal but also refraining from outputting the control signal may be referred to as control of the controller 515. For example, that the controller 515 outputs the first control signal for generation of AC power having a first frequency to the inverter 518 may mean that the controller 515 may output the control signals Q1_DRV and Q3_DRV for controlling the switches Q1 and Q3 in the on state during the first period corresponding to the first frequency and then output the control signals Q2_DRV and Q4_DRV for controlling the switches Q2 and Q4 in the on state during the second period corresponding to the first frequency, and repeat the above-described output operations. Meanwhile, that the controller 515 outputs the second control signal for generation of AC power having a second frequency to the inverter 518 may mean that the controller 515 may output the control signals Q1_DRV and Q3_DRV for controlling the switches Q1 and Q3 in the on state during the first period corresponding to the second frequency and then output the control signals Q2_DRV and Q4_DRV for controlling the switches Q2 and Q4 in the on state during the second period corresponding to the second frequency, and repeat the above-described output operations. In this case, the first period and the second period corresponding to the second frequency may differ from the first period and the second period corresponding to the first frequency. At least one of the DC/DC converter 517 or the inverter 518 may be referred to as a power providing circuit. The controller 515 may control the power providing circuit (e.g., at least one of the DC/DC converter 517 or inverter 518) so that power is applied to the transmission coil 513.

According to an embodiment, the AC power generated by the inverter 518 may be applied to the transmission coil 513. The capacitor 512 together with the transmission coil 513 may form a resonant circuit. The transmission coil 513 may form a magnetic field based on the applied AC power. Part of the magnetic field (or magnetic flux) formed by the transmission coil 513 may pass through the cross section of the reception coil 521 of the electronic device 203 which is the wireless power reception device. As the magnetic field passing through the cross section of the reception coil 521 is changed over time, an induced electromotive force (e.g., current, voltage, or power) may be generated around the reception coil 521.

According to an embodiment, the demodulation circuit 514 may demodulate the signal applied to the transmission coil 513 (e.g., the voltage 519 applied to both ends of the transmission coil 513) and output a demodulation signal Vdemod. The demodulation circuit 514 may output the demodulation signal Vdemod by down-converting the signal applied to the transmission coil 513 (e.g., the voltage 519 between both the ends) by the frequency (e.g., 100 kHz to 210 kHz) of the AC power. For example, the demodulation circuit 514 may include a mixer and/or a multiplier circuit for removing the carrier wave component (e.g., 100 kHz to 210 kHz which is the frequency of the AC power) for wireless power transmission. Here, since the mixed waveform of the component by the modulation of the electronic device 203 and the AC power component by the wireless power transmitting device 201 may be applied to both the ends of the coil 513 of the wireless power transmitting device 201, the frequency component (e.g., 100 kHz to 210 kHz) of the AC power is named the carrier wave component, but it will be appreciated by one of ordinary skill in the art that the electronic device 203 does not actually generate the electromagnetic wave which is the mixture of the carrier wave and the modulated data. Thus, the carrier wave component (e.g., the frequency of AC power, 100 kHz to 210 kHz) may be removed from the voltage 519 between both the ends of the transmission coil 513. The demodulation circuit 514 may additionally filter (low pass filter) the demodulation signal Vdemod and output it. The demodulation circuit 514 may include a low pass filter. Or, the demodulation circuit 514 may filter the voltage 519 between both the ends of the transmission coil 513 and then down-convert it by the frequency (e.g., 100 kHz to 210 kHz) of AC power, thereby generating the demodulation signal Vdemod. The amplitude of the voltage 519 between both the ends of the transmission coil 513 may be changed according to the ASK demodulation of the electronic device 203. According to an embodiment, the controller 515 may identify the information provided from the electronic device 203, based on the demodulation signal Vdemod output by the demodulation circuit 514. The controller 515 may perform, e.g., analog-to-digital conversion (ADC) on the demodulation signal Vdemod. The controller 515 may decode the digital value obtained as a result of the ADC and identify the information provided by the electronic device 203 according to the result of decoding. It will be understood by those skilled in the art that the decoding method may be based on, e.g., the Qi standard, but is not limited thereto. Meanwhile, in the above-described embodiment, the demodulation circuit 514 performs frequency down-conversion (e.g., carrier wave removal) and/or low-pass filtering, and the controller 515 performs ADC and/or decoding, but this is merely an example. It will be appreciated by one of ordinary skill in the art that the demodulation circuit 514 may be implemented to further perform at least one of ADC or decoding, and the controller 515 may be implemented to further perform frequency down-conversion (e.g., carrier wave removal) and/or low-pass filtering.

According to an embodiment, the electronic device 203 which is a wireless power reception device may include at least one of a reception coil 521 (e.g., the coil 420 of FIGS. 4B and 4C), a capacitor 522, a capacitor 523, a rectification circuit 555, a controller 550 (e.g., the processor 120 of FIG. 1 or the processor 410 of FIG. 4C), a plurality of capacitors 561, 562, 563, and 564, a plurality of switches 531, 532, 533, and 534, a capacitor 541, a regulator 542, a capacitor 543, or a charger 544.

According to an embodiment, the reception coil 521, the capacitor 522, and the capacitor 523 may constitute a resonance circuit. One end of the capacitor 522 may be connected to the reception coil 521, and the other end of the capacitor 522 may be connected to one end of the capacitor 523 and one end of the rectification circuit 555. One end of the capacitor 523 may be connected to the other end of the capacitor 522, and the other end of the capacitor 523 may be connected to the other end of the reception coil 521. In other words, the capacitor 523 may be connected in parallel to a circuit formed by connecting the reception coil 521 and the capacitor 522 in series. The other end of the capacitor 523 may be connected to the other end of the rectification circuit 555.

According to an embodiment, the rectification circuit 555 may include a plurality of switches S1, S2, S3, and S4 constituting the full bridge circuit. One end of the resonance circuit may be connected to a connection point between the switches S1 and S2, and the other end of the resonance circuit may be connected to the connection point between the switches S3 and S4. The rectification circuit 555 may convert the AC power, received through the reception coil 521, into DC power. The controller 550 may control the on/off states of the plurality of switches S1, S2, S3, and S4 to convert AC power into DC power.

According to an embodiment, the capacitor 541 and the regulator 542 may be connected to the rectification circuit 555. One end of the capacitor 541 may be grounded. The regulator 542 may perform converting (e.g., buck converting and/or boost converting) and/or regulating on the voltage of the rectified power output from the power conversion circuit.

According to an embodiment, the charger 544 may charge a battery (e.g., the battery 430 of FIGS. 4B and 4C) with the power converted and/or regulated by the regulator 542. According to an embodiment, the charger 544 may control the voltage and/or current for charging the battery according to a battery charging mode (e.g., constant current (CC) mode, constant voltage (CV) mode, or quick charging mode). According to the implementation, a PMIC (not shown) in place of the charger 244 may be coupled to the regulator 542.

According to an embodiment, the controller 550 may perform modulation in response to information to be provided. The controller 550 may determine a capacitor to be modulated from among the plurality of capacitors 561, 562, 563, and 564. The difference in amplitude of the voltage 519 sensed by the wireless power transmitting device 201 may be changed according to the capacitor to be modulated. For example, it is assumed that the difference in the amplitude of the voltage 519 sensed in the wireless power transmitting device 201 (e.g., the difference between the maximum amplitude of the voltage 519 while the switch 531 is in the on state and the maximum amplitude of the voltage 519 while the switch 531 is in the off state) when modulation is performed with only one capacitor 561 is a first value. In this case, since the capacitors 562, 563, and 564 are not used for modulation, the switches 532, 533, and 534 may remain off. Meanwhile, the difference in the amplitude of the voltage 519 sensed in the wireless power transmitting device 201 (e.g., the difference between the maximum amplitude of the voltage 519 while the switches 531 and 532 are in the on state and the maximum amplitude of the voltage 519 while the switches 531 and 532 are in the off state) when modulation is performed with the capacitor 561 and the capacitor 562 is a second value which may be larger than the first value. In this case, since the capacitors 563 and 564 are not used for modulation, the switches 533 and 534 may remain off. The electronic device 203 may adjust the modulation degree (or modulation depth) as the capacitor to be modulated among the plurality of capacitors 561, 562, 563, and 564 is adjusted. As described above, the controller 550 may output and/or refrain from outputting at least some of the control signals CMA1, CMA2, CMB1, and CMB2 to maintain the off state of the switch corresponding to the capacitor, not determined, while performing modulation using the determined capacitor. Meanwhile, for example, the capacitance of the capacitor 562 may be smaller than the capacitance of the capacitor 561, and the capacitance of the capacitor 564 may be smaller than the capacitance of the capacitor 563, but this is merely an example, and the size relationship in capacitance is not limited thereto, and the capacitances may be identical.

The controller 515 described above in FIG. 3 may be referred to as a processor and may be a micro controlling unit (MCU), a field programmable gate array (FPGA), an application specific integrated circuit (ASIC), at least one processor, or an application processor (AP). The wireless power transmission device 201 and the electronic device 203 which is a wireless power reception device are not limited to the configurations described above in FIG. 3, and may further include other components required for wireless charging.

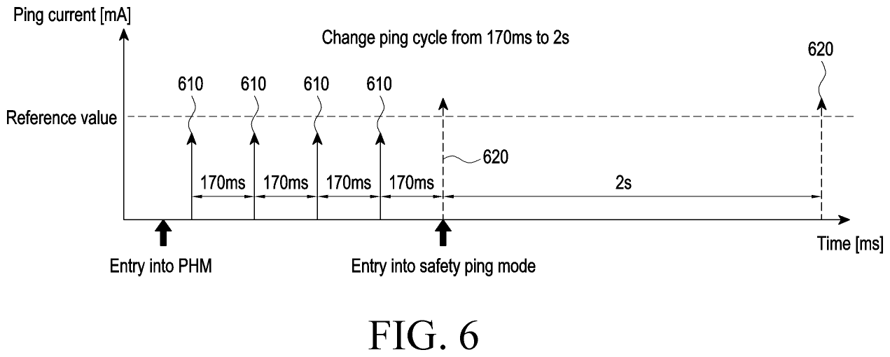

FIG. 6 is a view illustrating an example of a ping step for wireless charging according to an embodiment of the disclosure.

Referring to FIGS. 2, 3, 4A, 4B, 4C, 5, and 6, the wireless power transmission device 201 according to an embodiment may perform a ping phase to identify that an external object (e.g., the electronic device 203) is placed (e.g., disposed or attached) on or removed (e.g., detached) from the charging area by the controller 515, and determine whether a foreign object is present (e.g., distinguish between an object capable of wireless power reception and a foreign object). Here, the charging area of the wireless power transmission device 201 may be configured in a portion of the housing 310 of the wireless power transmission device 201 (e.g., a surface opposite to the surface placed on the floor, or an upper surface). The ping phase may be an operation of outputting (e.g., applying first power) a first ping signal to the transmission coil 513 for a designated time (e.g., a first ping cycle) when the first current value output from the converter 517 is applied to the inverter 518.

The wireless power transmission device 201 according to an embodiment may control the inverter 518 included in the power providing circuit to output (e.g., apply the first power) the first ping signal 610 to the transmission coil 513 while performing the ping phase at the designated first ping cycle (e.g., 170 ms). Here, the first power may be the power of a first frequency transmitted through the transmission coil 513 to identify whether an external object (e.g., the electronic device 203) is identified (e.g., present, detected, or confirmed) on the charging area in the ping phase. The wireless power transmission device 201 according to an embodiment may detect information (e.g., first information) related to the ping phase while performing the ping phase (e.g., applying the first power) to the transmission coil 513. Here, the information related to the ping phase may include at least one of a quality (Q) factor value, a resonance frequency, or an L/R value detected while performing the ping phase. The controller 215 according to an embodiment may identify that an external object is placed in the charging area based on the obtained information related to the ping phase and reference information.

According to an embodiment, the wireless power transmission device 201 may transmit the first ping signal 610 having a first current value to the electronic device 203 at the first ping cycle (e.g., 170 ms), used to identify the approach of the electronic device 203 while performing the ping phase in a power hold mode (PHM). According to an embodiment, if the electronic device 203 which is a wireless power reception device receives the first ping signal 610, the electronic device 203 may transmit a response signal to the first ping signal 610 to the wireless power transmission device 201. According to an embodiment, the electronic device 203 may identify the power hold mode (PHM) based on a predesignated condition. The electronic device 203 may share information about entry and release of the power hold mode with the wireless power transmission device 201.

According to an embodiment, if the wireless power transmission device 201 receives a response to the first ping signal 610 from the electronic device 203 while performing the ping operation, the electronic device 203 may be identified as a device (e.g., an object) that is disposed within a designated distance from the wireless power transmission device 201 and may actually receive wireless power. According to an embodiment, the wireless power transmission device 201 may enter a safety ping mode from the power hold mode (PHM) and change the first ping cycle (e.g., 170 ms) to a second ping cycle (e.g., 2 s). According to an embodiment, the wireless power transmission device 201 may transmit a second ping signal 620 having a current value equal to or larger than a reference value. The second ping signal 620 has a second current value equal to or larger than a reference value (e.g., a P-FOD entry value), and may be transmitted to the electronic device 203 at the second ping cycle. The second ping cycle may be set to be longer than the first ping cycle to reduce heat generation by the hinge member 230 while charging the battery 430 of the electronic device 203. The second ping cycle may be set in the wireless power transmission device 201, e.g., when the product is produced or initialized, shared with the electronic device 203, or set in each of the wireless power transmission device 201 and the electronic device 203 when the product is produced or initialized. The first ping cycle may be set in the wireless power transmission device 201, e.g., when the product is produced or initialized, shared with the electronic device 203, or set in each of the wireless power transmission device 201 and the electronic device 203 when the product is produced or initialized. According to an embodiment, if the electronic device 203 which is a wireless power reception device receives the second ping signal, the electronic device 203 may transmit a response signal to the second ping signal to the wireless power transmission device 201.

According to an embodiment, the wireless power transmission device 201 may perform at least one operation corresponding to an identification phase & configuration phase with the electronic device 203, and the corresponding operation may follow, e.g., the Qi standard, but is not limited. After performing the configuration phase, the wireless power transmission device 201 may perform a negotiation phase and a power transfer phase of transmitting power for charging the battery to the electronic device 203.

Referring back to FIGS. 2, 3, 4A to 4C, 5, and 6, if the electronic device 203 according to an embodiment performs the ping phase by the processor 410 to identify that the electronic device 203 is disposed within a designated distance from the wireless power transmission device 201, the electronic device 203 may identify receiving power for wirelessly charging the battery 430 from the wireless power transmission device 201 through the coil 420. The electronic device 203 according to an embodiment may identify whether it enters the power hold mode (PHM) by the processor 410 while charging the battery 430. If entering the power hold mode, the electronic device 203 may operate in the power hold mode and, if receiving the first ping signal 610 from the wireless power transmission device 201 through the ping phase in the power hold mode, the electronic device 203 may transmit a response message to the first ping signal 610 to the wireless power transmission device 201.

According to an embodiment, if the processor 410 of the electronic device 203 receives the second ping signal 620 having the second cycle and the second current value from the wireless power transmission device 201 while in the power hold mode (PHM), it may identify that the first ping cycle has been changed to the second ping cycle by the wireless power transmission device 201. The electronic device 203 may wirelessly receive power from the wireless power transmission device 201 and maintain the state of charging the battery 430. According to an embodiment, the processor 410 of the electronic device 203 may control the light output circuit 450 to output light of a first color (e.g., green light) indicating the state of charging the battery 430 based on wirelessly receiving power from the wireless power transmission device 201 without stopping the battery charging and maintaining the state of charging the battery 430. According to an embodiment, the processor 410 of the electronic device 203 may control the display 460 to display information (e.g., a text or graphic object) indicating the state of charging the battery 430.

According to an embodiment, if the processor 410 of the electronic device 203 identifies that none of another first ping signal and the second ping signal are received for a designated time (e.g., 2.2 seconds) after receiving the first ping signal, the processor 410 may stop the charging of the battery 430 and control the light output circuit 450 to output light of a second color (e.g., red light) indicating that the charging of the battery 430 is stopped. According to an embodiment, the processor 410 of the electronic device 203 may control the display 460 to display information (e.g., a text or graphic object) indicating that charging of the battery 430 is stopped.

According to an embodiment, the memory 440 of the electronic device may store commands (e.g., instructions) for implementing the software module. The memory 440 according to an embodiment may store information related to wireless charging and may store various data generated while executing the program as well as the program (e.g., software or the program 140 of FIG. 1) related to wireless charging. The memory 440 according to an embodiment may store commands (or instructions) enabling at least one processor (e.g., the processor 120 of FIG. 1 or the processor 410 of FIG. 4C) to perform wireless charging.

According to an embodiment, the software module of the electronic device may include a kernel (or HAL), a framework (e.g., the middleware 144 of FIG. 1) and an application (e.g., the application 146 of FIG. 1 or the message application of FIG. 2). At least part of the program module may be preloaded on the electronic device or may be downloaded from a server (e.g., the server 108). The application may include an application received from an external electronic device (e.g., the server 108 or the electronic devices 102 and 104). According to an embodiment, the application may include a preloaded application or a third party application downloadable from a server. The components of the software module and the names of the components according to the illustrated embodiment may be varied depending on the type of the operating system. According to an embodiment, at least a part of the software module may be implemented in software, firmware, hardware, or in a combination of two or more thereof. At least part of the software module may be implemented (e.g., executed) by e.g., a processor (e.g., an AP). At least a part of the software module may include at least one of, e.g., a module, program, routine, set of instructions, process, or the like for performing at least function.

The light output circuit 450 according to an embodiment may be disposed on a portion of the first housing 210 or a portion of the second housing 220, and may include a light emitting diode (LED) that generates light. According to an embodiment, if the charging of the battery 430 is maintained, the light output circuit 450 may output light of the first color (e.g., green light) indicating that the battery is being charged. According to an embodiment, if the charging of the battery 430 is stopped, the light output circuit 450 may output light of the second color (e.g., red light) indicating that the charging of the battery 430 is stopped.

The display 460 (e.g., the display 160 of FIG. 1) according to an embodiment may be included in a portion of the second housing 210, and may display various information related to wireless charging based on the control of at least one processor 410. According to an embodiment, if the charging of the battery 430 is maintained, the display 460 may output information (e.g., a text or graphic object) indicating that the battery is being charged. According to an embodiment, if the charging of the battery 430 is stopped, the display 460 may output information (e.g., a text or graphic object) indicating that the charging of the battery 430 is stopped.

The electronic device 203 according to an embodiment may further include a communication circuit, and the communication circuit may perform wireless communication with an external electronic device (e.g., the external electronic devices 205a and 205b or other external electronic devices) seated on the electronic device 203 and transmit various information related to wireless charging. For example, if the charging of the battery 430 is maintained, the communication circuit may transmit information indicating that the battery is being charged (e.g., a text or graphic object) to an external electronic device. For example, if the charging of the battery 430 is stopped, the communication circuit may transmit information (e.g., a text or graphic object) indicating that the charging of the battery is stopped.

As described above, in an embodiment, major components of the electronic device have been described through the electronic devices 101 and 203 of FIGS. 1, 4A, 4B, 4C, and 5. In various embodiments, however, all of the components of FIGS. 1, 4A, 4B, 4C, and 5 are not essential components, and the electronic device 101 or 203 may be implemented with more or less components than those shown. The positions of the major components of the electronic device 101 or 203 described above in connection with FIGS. 1, 4A, 4B, 4C, and 5 may be varied according to various embodiments.

According to an embodiment, an electronic device (e.g., the electronic device 101 of FIG. 1 or the electronic device 203 of FIGS. 2, 4A, 4B, 4C, and 5) may comprise a first housing (e.g., the first housing 210 of FIGS. 2 and 4A), a second housing (e.g., the second housing 220 of FIGS. 2 and 4A) rotatably connected to a portion of the first housing to be opened or closed, a hinge member (e.g., the hinge member 230 of FIGS. 2 and 4A) rotatably connecting the first housing and the second housing and including a metal material, a coil (e.g., the coil 420 of FIGS. 4B and 4C and the coil 521 of FIG. 5) disposed adjacent to the hinge member in the first housing, a battery (e.g., the battery 430 of FIGS. 4B and 4C) disposed in the first housing, at least one processor (e.g., the processor 120 of FIG. 1 or the processor 410 of FIG. 4C), and memory (e.g., the memory 130 of FIG. 1 or the memory 440 of FIG. 4C) storing instructions.

According to an embodiment, the instructions may, when executed by the at least one processor individually or collectively, enable the electronic device to, based on identifying that the electronic device is disposed within a designated distance from a wireless power transmission device (e.g., the wireless power transmission device 201 of FIGS. 2, 3, and 5) using a first ping signal received from the wireless power transmission device and having a first cycle and a first current value, receive power for wirelessly charging the battery through the coil from the wireless power transmission device.

According to an embodiment, the instructions may, when executed by the at least one processor individually or collectively, enable the electronic device to identify entry into a power hold mode (PHM) while receiving the power.

According to an embodiment, the instructions may, when executed by the at least one processor individually or collectively, enable the electronic device to, based on receiving a second ping signal having a second cycle and a second current value from the wireless power transmission device while in the power hold mode, identify that the first ping cycle is changed to the second ping cycle by the wireless power transmission device and maintain a state of charging the battery by wirelessly receiving the power from the wireless power transmission device without stopping the charging of the battery.

According to an embodiment, the second current value of the second ping signal may be greater or equal to a reference value.

According to an embodiment, the second ping cycle may be longer than the first ping cycle to reduce heat generation by the hinge member while charging the battery of the electronic device.

According to an embodiment, the electronic device may further comprise a light output circuit (e.g., the light output circuit 450 of FIG. 4C). According to an embodiment, the instructions may, when executed by the at least one processor individually or collectively, enable the electronic device to, based on maintaining the state of charging the battery by wirelessly receiving the power from the wireless power transmission device without stopping the charging of the battery, output, through the light output circuit, light of a first color indicating the state of charging the battery.

According to an embodiment, the instructions may, when executed by the at least one processor individually or collectively, enable the electronic device to, based on identifying that the first ping signal and the second ping signal are not received for a designated time, stop the charging of the battery and output, through the light output circuit, light of a second color indicating that the charging of the battery has stopped. According to an embodiment, the designated time may be pre-designated based on the second ping cycle.

According to an embodiment, the second ping cycle may be set by the wireless power transmission device when the wireless power transmission device enters a safe ping mode.

According to an embodiment, the electronic device may further comprise a display (e.g., the display 460 of FIG. 4C).

According to an embodiment, the instructions may, when executed by the at least one processor individually or collectively, enable the electronic device to display, on the display, information indicating the state of charging the battery.

According to an embodiment, the second ping cycle may be shorted than the designated time.

According to an embodiment, the instructions may, when executed by the at least one processor individually or collectively, enable the electronic device to, based on identifying that the first ping signal and the second ping signal are not received for a designated time, stop the charging of the battery and output, through the display, information indicating that the charging of the battery has stopped.

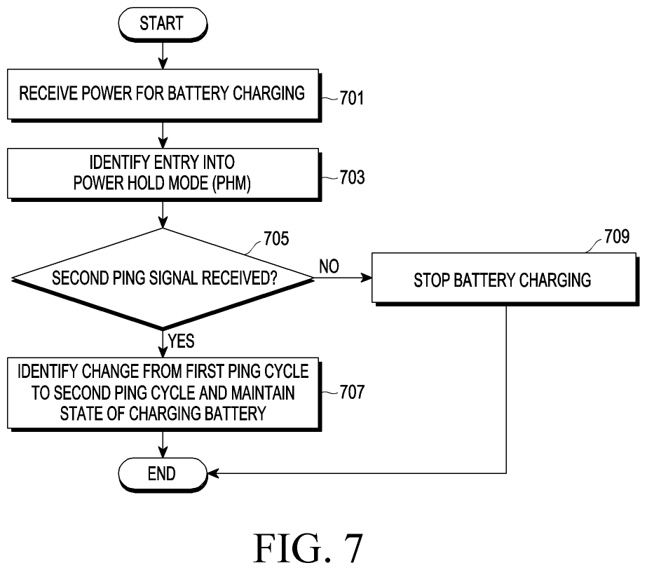

FIG. 7 is a view illustrating an example of an operation method in an electronic device according to an embodiment of the disclosure. In the following embodiments, each operation may be performed sequentially, but is not necessarily performed sequentially. For example, the order of the operations may be changed, and at least two operations may be performed in parallel.

Referring to FIG. 7, in operation 701, an electronic device (e.g., the electronic device 101 of FIG. 1 or the electronic device 203 of FIGS. 2, 4A, 4B, 4C, and 5) according to an embodiment may receive power for wirelessly charging a battery (e.g., the battery 430 of FIGS. 4B and 4C) through a coil (e.g., the coil 420 of FIGS. 4B and 4C or the coil 521 of FIG. 5) from a wireless power transmission device (e.g., the wireless power transmission device 201 of FIGS. 2 and 3) based on identifying that the electronic device is disposed within a designated distance from the wireless power transmission device (e.g., the wireless power transmission device 201 of FIGS. 2, 3, and 5) using a first ping signal. The first ping signal is received from the wireless power transmission device and has a first period and a first current value. The coil of the electronic device may be disposed in a first housing (e.g., the first housing 210 of FIGS. 2, 4A, and 4B), adjacent to a hinge member (e.g., the hinge member 230 of FIGS. 2, 4B, and 4C) including a metal material rotatably connecting the first housing of the electronic device and a second housing (e.g., the second housing 220 of FIGS. 2, 4A, and 4B) of the electronic device.

In operation 703, the electronic device may identify entry into a power hold mode (PHM) while receiving the power. If the electronic device receives the first ping signal at a first ping cycle (e.g., 170 ms) from the wireless power transmission device while in the power hold mode, the electronic device may transmit a response signal to the received first ping signal to the wireless power transmission device.

In operation 705, the electronic device may identify whether it receives a second ping signal having a second cycle and a second current value within a designated time from the wireless power transmission device while in the power hold mode. As a result of the identification, if the electronic device receives the second ping signal, the electronic device may perform operation 707. As a result of the identification, if the electronic device does not receive the second ping signal, the electronic device may perform operation 709. Here, the second current value of the second ping signal may be larger than or equal to a reference value (e.g., a P-FOD entry value). The second ping cycle may be set to be longer than the first ping cycle to reduce heat generation by the hinge member while charging the battery of the electronic device, and may be set by the wireless power transmission device when the wireless power transmission device enters the safety ping mode. In operation 705, the electronic device may identify whether the first ping signal is not received within the first ping cycle after receiving the first ping signal at the first ping cycle, and whether the second ping signal is received within the designated time.

In operation 707, the electronic device may identify that the first ping cycle is changed to the second ping cycle by the wireless power transmission device based on identifying that the second ping signal is received from the wireless power transmission device within the designated time while in the power hold mode, and may perform an operation of maintaining the state of charging the battery without stopping battery charging. The electronic device may output light of a first color indicating the state of charging the battery through the light output circuit of the electronic device. According to an embodiment, the electronic device may display information (e.g., a text or graphic object) indicating the state of charging the battery through the display. The electronic device may transmit a response signal to the received second ping signal based on identifying that the second ping signal is received within the designated time from the wireless power transmission device while in the power hold mode.

In operation 709, the electronic device may perform an operation of stopping the charging of the battery based on identifying that the second ping signal is not received within the designated time from the wireless power transmission device while in the power hold mode. The electronic device may output light of the second color, indicating that the charging of the battery is stopped, through the light output circuit of the electronic device. According to an embodiment, the electronic device may display information (e.g., a text or graphic object) indicating that the charging of the battery is stopped through the display. In operation 709, the electronic device may identify that the first ping signal is not received within the first ping cycle and the second ping signal is not received within the designated time after receiving the first ping signal at the first ping cycle. As the electronic device identifies that neither the first ping signal nor the second ping signal is received within the designated time, the electronic device may identify the electronic device as being detached from the wireless power transmission device, and may stop charging the battery.

According to an embodiment, if the second ping signal is received at the second ping cycle, but another first ping signal and another second ping signal are not received thereafter, the electronic device may identify that it is detached from the wireless power transmission device, and stop charging the battery.

An example in which the electronic device 203 in the operation method described above in FIG. 7 is a cradle device configured in the form of a case capable of storing an external electronic device (e.g., the external electronic devices 205a and 205b of FIG. 4A) has been described above, but the operation method described above in FIG. 7 may also be applied to foldable or flip-type electronic devices in which a portion of the housing is folded.

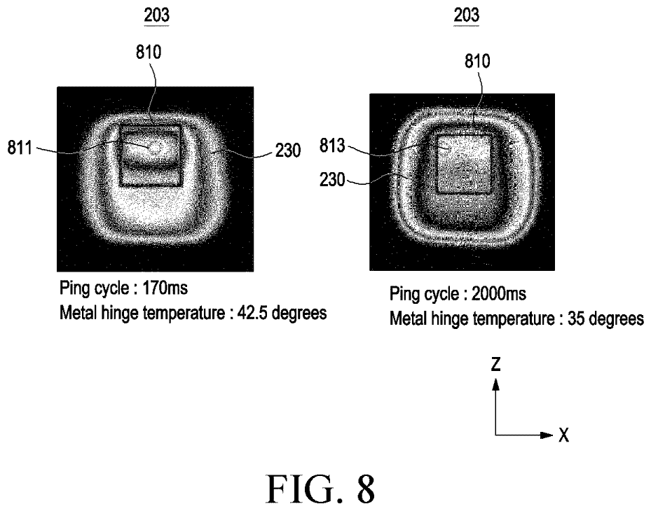

FIG. 8 is a view illustrating an effect according to wireless charging in an electronic device according to an embodiment of the disclosure. Here, as shown in FIG. 4B, FIG. 8 shows the rear surface of the electronic device 203, and is a view of comparing temperature changes before and after enhancement for wireless charging heat generation of the connection member (e.g., a hinge member) 230.

Referring to FIG. 8, when the ping current is high, the wireless power transmission device according to an embodiment may change the ping cycle from the first ping cycle (e.g., 170 ms) to the second ping cycle (e.g., 2,000 ms) so that the electronic device 203 which is a wireless power reception device may identify the change to the second ping cycle, and the electronic device 203 may maintain the battery charging to prevent disconnection of charging, thereby enhancing wireless charging heat generation. As illustrated in FIG. 8, the disclosure may compare the temperature changes before and after enhancement of wireless charging heat generation by comparing the maximum temperature 811 (e.g., 42.5 degrees C.) measured at a portion 810 (e.g., the measurement position) of the connection member 230 (e.g., a hinge member including a metal material) of the electronic device 203 at the first ping cycle (e.g., 170 ms) and the maximum temperature 813 (e.g., 35 degrees C.) measured at a portion of the connection member 230 at the second ping cycle (e.g., 2,000 ms). As illustrated in FIG. 8, as the ping cycle is changed to the second ping cycle (e.g., 2,000 ms) which is longer than the first ping cycle (e.g., 170 ms), the temperature of the portion 810 of the connection member 230 of the electronic device 203 is lowered from the temperature (e.g., the maximum temperature 811) (e.g., 42.5 degrees C. before enhancement of the first ping cycle (e.g., 170 ms) to the temperature (e.g., the maximum temperature 813) (e.g., 35 degrees C.) after enhancement of the second ping cycle (e.g., 2,000 ms), and thus, the disclosure may enhance wireless charging heat generation. Since the electronic device 203 which is a wireless power reception device according to the disclosure requires determination as to whether it is detached from the wireless power transmission device so that a ping is not received or the ping cycle is prolonged in the safety ping mode, it is possible to enhance wireless charging heat generation by preventing disconnection of charging by setting the cycle of the safety ping mode to the time (e.g., 2,000 ms) of maintaining the LED.

According to an embodiment, a method of an operation in an electronic device (e.g., the electronic device 101 of FIG. 1 or the electronic device 203 of FIGS. 2, 4A, 4B, 4C, and 5) may comprise, based on identifying that the electronic device is disposed within a designated distance from a wireless power transmission device (e.g., the wireless power transmission device 201 of FIGS. 2, 3, and 5) using a first ping signal received from the wireless power transmission device and having a first cycle and a first current value, receiving power for wirelessly charging a battery (e.g., the battery 430 of FIGS. 4B and 4C) through a coil (e.g., the coil 420 of FIGS. 4B and 4C) of the electronic device from the wireless power transmission device. According to an embodiment, the coil may be configured to be disposed in a first housing, adjacent to a hinge member (e.g., the hinge member 230 of FIGS. 2 and 4A) including a metal material rotatably connecting the first housing (e.g., the first housing 210 of FIGS. 2 and 4A) of the electronic device and a second housing (e.g., the second housing 220 of FIGS. 2 and 4A) of the electronic device.

According to an embodiment, the method may comprise identifying entry into a power hold mode (PHM) while receiving the power.

According to an embodiment, the method may comprise, based on receiving a second ping signal having a second cycle and a second current value from the wireless power transmission device while in the power hold mode, identifying that the first ping cycle is changed to the second ping cycle by the wireless power transmission device and maintaining a state of charging the battery by wirelessly receiving the power from the wireless power transmission device without stopping the charging of the battery.

According to an embodiment, the second current value of the second ping signal may be greater or equal to a reference value.

According to an embodiment, the second ping cycle may be longer than the first ping cycle to reduce heat generation by the hinge member while charging the battery of the electronic device.

According to an embodiment, the method may further comprise, based on maintaining the state of charging the battery by wirelessly receiving the power from the wireless power transmission device without stopping the charging of the battery, outputting, through a light output circuit (e.g., the light output circuit 450 of FIG. 4C) of the electronic device, light of a first color indicating the state of charging the battery.

According to an embodiment, the method may further comprise, based on identifying that the first ping signal and the second ping signal are not received for a designated time, stopping the charging of the battery and outputting, through the circuit, light of a second color indicating that the charging of the battery has stopped.

According to an embodiment, the designated time may be pre-designated based on the second ping cycle.

According to an embodiment, the second ping cycle may be set by the wireless power transmission device when the wireless power transmission device enters a safe ping mode.

According to an embodiment, the method may further comprise display, on a display (e.g., the display 460 of FIG. 4C) of the electronic device, information indicating the state of charging the battery.

According to an embodiment, the second ping cycle may be shorter than the designated time.

According to an embodiment, the method may further comprise, based on identifying that the first ping signal and the second ping signal are not received for the designated time, stopping the charging of the battery and outputting, through the display, information indicating that the charging of the battery has stopped.

According to an embodiment, in a non-transitory storage medium storing one or more programs, the one or more programs may include instructions that, when executed by at least one processor of an electronic device, enable the electronic device to, based on identifying that the electronic device is disposed within a designated distance from a wireless power transmission device using a first ping signal received from the wireless power transmission device and having a first cycle and a first current value, receive power for wirelessly charging the battery through a coil of the electronic device from the wireless power transmission device, the coil configured to be disposed in a first housing (e.g., the first housing 210 of FIGS. 2 and 4A), adjacent to a hinge member (e.g., the hinge member 230 of FIGS. 2, 4A, and 4B) including a metal material rotatably connecting the first housing of the electronic device and a second housing (e.g., the second housing 220 of FIGS. 2 and 4A) of the electronic device, identify entry into a power hold mode (PHM) while receiving the power, and based on receiving a second ping signal having a second cycle and a second current value from the wireless power transmission device while in the power hold mode, identify that the first ping cycle is changed to the second ping cycle by the wireless power transmission device and maintain a state of charging the battery by wirelessly receiving the power from the wireless power transmission device without stopping the charging of the battery.

According to an embodiment, the second current value of the second ping signal is a reference value or more, and the second ping cycle may be longer than the first ping cycle to reduce heat generation by the hinge member while charging the battery of the electronic device.

According to an embodiment, the one or more programs may include the instructions that, when executed by the at least one processor of the electronic device, enable the electronic device to, based on maintaining the state of charging the battery by wirelessly receiving the power from the wireless power transmission device without stopping the charging of the battery, output, through a light output circuit of the electronic device, light of a first color indicating the state of charging the battery.

According to an embodiment, the one or more programs may include the instructions that, when executed by the at least one processor of the electronic device, enable the electronic device to: based on identifying that the first ping signal and the second ping signal are not received for a designated time, stop the charging of the battery and output, through the light output circuit, light of a second color indicating that the charging of the battery has stopped.

According to an embodiment, the designated time may be pre-designated based on the second ping cycle.

According to an embodiment, the second ping cycle may be set by the wireless power transmission device when the wireless power transmission device enters a safe ping mode.

According to an embodiment, the one or more programs may include the instructions that, when executed by the at least one processor of the electronic device, enable the electronic device to display, on a display of the electronic device, information indicating the state of charging the battery.

According to an embodiment, the second ping cycle may be shorted than the designated time.

According to an embodiment, the one or more programs may include the instructions that, when executed by the at least one processor of the electronic device, enable the electronic device to, based on identifying that the first ping signal and the second ping signal are not received for the designated time, stop the charging of the battery and output, through the display, information indicating that the charging of the battery has stopped.

The disclosure may mitigate heat generation by a hinge member when performing wireless charging in a power hold mode in an electronic device having the hinge member configured adjacent to a coil. Other various effects may be provided directly or indirectly in the disclosure. Effects obtainable from the disclosure are not limited to the above-mentioned effects, and other effects not mentioned may be apparent to one of ordinary skill in the art from the following description.

The embodiments disclosed herein are proposed for description and understanding of the disclosed technology and does not limit the scope of the disclosure. Accordingly, the scope of the disclosure should be interpreted as including all changes or various embodiments based on the technical spirit of the disclosure.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a first housing;
a second housing rotatably connected to a portion of the first housing to be opened or closed;
a hinge member rotatably connecting the first housing and the second housing and including a metal material;
a coil disposed adjacent to the hinge member in the first housing;
a battery disposed in the first housing;
memory, comprising one or more storage media, storing instructions; and
at least one processor communicatively coupled to the battery and the memory,
wherein the instructions, when executed by the at least one processor individually or collectively, cause the electronic device to:
based on identifying that the electronic device is disposed within a designated distance from a wireless power transmission device using a first ping signal received from the wireless power transmission device and having a first cycle and a first current value, receive power for wirelessly charging the battery through the coil from the wireless power transmission device,
identify entry into a power hold mode (PHM) while receiving the power, and
based on receiving a second ping signal having a second cycle and a second current value from the wireless power transmission device while in the power hold mode, identify that the first ping cycle is changed to the second ping cycle by the wireless power transmission device and maintain a state of charging the battery by wirelessly receiving the power from the wireless power transmission device without stopping the charging of the battery,
wherein the second current value of the second ping signal is greater or equal to a reference value, and
wherein the second ping cycle is longer than the first ping cycle to reduce heat generation by the hinge member while charging the battery of the electronic device.

2. The electronic device of claim 1, further comprising:
a light output circuit,
wherein the instructions, when executed by the at least one processor individually or collectively, further cause the electronic device to, based on maintaining the state of charging the battery by wirelessly receiving the power from the wireless power transmission device without stopping the charging of the battery, output, through the light output circuit, light of a first color indicating the state of charging the battery.

3. The electronic device of claim 2,
wherein the instructions, when executed by the at least one processor individually or collectively, further cause the electronic device to, based on identifying that the first ping signal and the second ping signal are not received for a designated time, stop the charging of the battery and output, through the light output circuit, light of a second color indicating that the charging of the battery has stopped; and
wherein the designated time is pre-designated based on the second ping cycle.

4. The electronic device of claim 1, wherein the second ping cycle is set by the wireless power transmission device when the wireless power transmission device enters a safe ping mode.

5. The electronic device of claim 3, further comprising:
a display,
wherein the instructions, when executed by the at least one processor individually or collectively, further cause the electronic device to, display, on the display, information indicating the state of charging the battery, and
wherein the second ping cycle is shorter than the designated time.

6. The electronic device of claim 5, wherein the instructions, when executed by the at least one processor individually or collectively, further cause the electronic device to:
based on identifying that the first ping signal and the second ping signal are not received for the designated time, stop the charging of the battery and output, through the display, information indicating that the charging of the battery has stopped.

7. A method operating an electronic device, the method comprising:
based on identifying that the electronic device is disposed within a designated distance from a wireless power transmission device using a first ping signal received from the wireless power transmission device and having a first cycle and a first current value, receiving power for wirelessly charging a battery through a coil of the electronic device from the wireless power transmission device, wherein the coil is configured to be disposed in a first housing, adjacent to a hinge member including a metal material rotatably connecting the first housing of the electronic device and a second housing of the electronic device;
identifying entry into a power hold mode (PHM) while receiving the power; and
based on receiving a second ping signal having a second cycle and a second current value from the wireless power transmission device while in the power hold mode, identifying that the first ping cycle is changed to the second ping cycle by the wireless power transmission device and maintaining a state of charging the battery by wirelessly receiving the power from the wireless power transmission device without stopping the charging of the battery,
wherein the second current value of the second ping signal is greater or equal to a reference value, and
wherein the second ping cycle is longer than the first ping cycle to reduce heat generation by the hinge member while charging the battery of the electronic device.

8. The method of claim 7, further comprising, based on maintaining the state of charging the battery by wirelessly receiving the power from the wireless power transmission device without stopping the charging of the battery, outputting, through a light output circuit of the electronic device, light of a first color indicating the state of charging the battery.

9. The method of claim 8, further comprising:
based on identifying that the first ping signal and the second ping signal are not received for a designated time, stopping the charging of the battery and outputting, through the light output circuit, light of a second color indicating that the charging of the battery has stopped,
wherein the designated time is pre-designated based on the second ping cycle.

10. The method of claim 7, wherein the second ping cycle is set by the wireless power transmission device when the wireless power transmission device enters a safe ping mode.

11. The method of claim 9, further comprising displaying, on a display of the electronic device, information indicating the state of charging the battery.

12. The method of claim 11, wherein the second ping cycle is shorter than the designated time.

13. The method of claim 12, further comprising, based on identifying that the first ping signal and the second ping signal are not received for the designated time, stopping the charging of the battery and outputting, through the display, information indicating that the charging of the battery has stopped.

14. One or more non-transitory computer-readable storage media storing one or more computer programs including computer-executable instructions that, when executed by at least one processor of an electronic device individually or collectively, cause the electronic device to perform operations, the operations comprising:
based on identifying that the electronic device is disposed within a designated distance from a wireless power transmission device using a first ping signal received from the wireless power transmission device and having a first cycle and a first current value, receiving power for wirelessly charging a battery through a coil of the electronic device from the wireless power transmission device, wherein the coil is configured to be disposed in a first housing, adjacent to a hinge member including a metal material rotatably connecting the first housing of the electronic device and a second housing of the electronic device;
identifying entry into a power hold mode (PHM) while receiving the power; and
based on receiving a second ping signal having a second cycle and a second current value from the wireless power transmission device while in the power hold mode, identifying that the first ping cycle is changed to the second ping cycle by the wireless power transmission device and maintaining a state of charging the battery by wirelessly receiving the power from the wireless power transmission device without stopping the charging of the battery,
wherein the second current value of the second ping signal is greater or equal to a reference value, and
wherein the second ping cycle is longer than the first ping cycle to reduce heat generation by the hinge member while charging the battery of the electronic device.

15. The one or more non-transitory computer-readable storage media of claim 14, the operations further comprising:
based on maintaining the state of charging the battery by wirelessly receiving the power from the wireless power transmission device without stopping the charging of the battery, outputting, through a light output circuit of the electronic device, light of a first color indicating the state of charging the battery.

16. The one or more non-transitory computer-readable storage media of claim 15, the operations further comprising:
based on identifying that the first ping signal and the second ping signal are not received for a designated time, stopping the charging of the battery and output, through the light output circuit, light of a second color indicating that the charging of the battery has stopped,
wherein the designated time is pre-designated based on the second ping cycle.

17. The non-transitory storage medium of claim 14, wherein the second ping cycle is set by the wireless power transmission device when the wireless power transmission device enters a safe ping mode.

18. The non-transitory storage medium of claim 16, the operations further comprising:
displaying, on a display of the electronic device, information indicating the state of charging the battery.

19. The non-transitory storage medium of claim 18, wherein the second ping cycle is shorter than the designated time.

20. The non-transitory storage medium of claim 19, the operations further comprising:
based on identifying that the first ping signal and the second ping signal are not received for the designated time, stopping the charging of the battery; and outputting, through the display, information indicating that the charging of the battery has stopped.
